(19) United States
(12) Patent Application Publication
(10) Pub. No.: US 2010/0299956 A1
(43) Pub. Date: Dec. 2, 2010

(54) Apparatus and Method for Drying Wallboard

(75) Inventors: Thomas O'Brien, Mount Prospect, IL (US); John Michael Whitehouse, Naperville, IL (US)

Correspondence Address: BARNES & THORNBURG LLP, P.O. BOX 2786, CHICAGO, IL, 60690-2786, US

(73) Assignee: RECYCLED ENERGY DEVELOPMENT, LLC, Westmont, IL (US)

(21) Appl. No.: 12/765,274

(22) Filed: Apr. 22, 2010

Related U.S. Application Data
(60) Provisional application No. 61/182,353, filed on May 29, 2009.

(51) Int. Cl. F26B 3/00; F26B 25/00; F26B 19/00

(52) U.S. Cl. 34/500; 34/236; 34/86

(57) ABSTRACT

A process and apparatus used for heating and drying a material. The process uses supplemental radiant heat supplied by circulating thermal oil that is heated using fuels, as well as exhaust heat from other sources. The supplemental heat replaces a portion of the heat provided by the direct-firing. The supplemental heating is achieved by retrofitting existing direct-fired or radiant heat gypsum dryers with thermal oil-to-air heat exchangers in the combustion air lines and the air recirculation lines. Heated thermal oil is circulated through the exchangers, providing supplemental heat to both the combustion air and the re-circulated dryer air. The existing natural gas burners are fired to achieve the desired exit temperature. A Organic Rankine Cycle (ORC) system is coupled to the dryer exhaust vent to recapture heat energy produced by the thermal oil and produce electricity.

This application claims priority to U.S. Provisional Application Ser. No. 61/182,353 filed May 29, 2009, which is herein incorporated by reference in its entirety.

### BACKGROUND

The present disclosure relates to the process of drying gypsum board or other material using a heat source. Drywall is a common building material typically made of a layer of gypsum plaster pressed between two thick sheets of paper, then kiln dried. Drywall is used globally for the finish construction of interior walls and ceilings. Gypsum wallboard is manufactured by preparing a slurry of calcined gypsum and other additives with an excess of water, forming the slurry into a board form within an envelope of wallboard paper, and allowing the gypsum to harden while supported in board form. A great excess of water must then be removed, in a high temperature dryer. The moisture evaporates from the gypsum core by passing through the pores of the paper.

The airflow and humidity maintained in the dryer are crucial to maintain proper product properties. The dryers are typically composed of several temperature zones, starting at 600° F. The heat is supplied to the dryer through either direct fired combustion or radiant heat. The actual conditions in the dryer are dependant upon the product being produced and the production rate. Direct firing can be provided using a number of fuels, including natural gas, oil, biomass, etc. Radiant heat is supplied using steam or electricity. With either method, the hot air is circulated through the dryer several times, with a small purge taken off and vented to the atmosphere.

Most modern gypsum board kilns have gravitated to direct firing using natural gas. Other fuels, such as oil and biomass, create problems with ash contaminating the product. Steam has also fallen out of favor due to the fact it can only achieve temperatures of 450° F. without expensive upgrades to equipment and metallurgy. Electric heat has proven to be too costly.

### SUMMARY

The present disclosure is directed to a process and apparatus for drying gypsum wallboard or other material that needs to be heated. In illustrative embodiments, the process uses supplemental radiant heat supplied by circulating thermal oil that is heated using fuels, as well as exhaust heat from other sources. The supplemental heat replaces up to 90% of the heat provided by the direct-firing. By substituting direct-fired fuel, such as natural gas, with lower cost and/or renewable fuels, the system allows for significantly lower energy costs and potential reductions in greenhouse gas emissions.

In illustrative embodiments, the supplemental heating is achieved by retrofitting existing direct-fired or radiant heat gypsum dryers with thermal oil-to-air heat exchangers in the combustion air lines and the air recirculation lines. Heated thermal oil is circulated through the exchangers, providing supplemental heat to both the combustion air and the re-circulated dryer air. The existing natural gas burners are fired to achieve the desired exit temperature. The cooled thermal oil is returned to a heater where it is reheated to the required exit temperature.

In illustrative embodiments, a proprietary Organic Rankine Cycle (ORC) system is coupled to the dryer exhaust vent to recapture heat energy produced by the thermal oil. The exhaust stream from the dryer has a large amount of latent energy due to the high moisture content created by drying the gypsum board. The ORC system works by vaporizing a working fluid, such as propane or iso-butane, and passing the vapor through a turbine to produce electricity. The working fluid is then compressed and cooled, before being sent back to the vaporizer. In this case, the working fluid is vaporized by the heat coming from the exhaust of the gypsum board dryer.

Additional features of the present disclosure will become apparent to those skilled in the art upon consideration of the following detailed description of illustrative embodiments exemplifying the best mode of carrying out the disclosure as presently perceived.

### BRIEF DESCRIPTION OF THE DRAWINGS

The detailed description particularly refers to the accompanying figures in which:

FIG. 1 is a cross-sectional view of a wallboard dryer of the disclosure with portions broken away to show the heating and recovery system.

### DETAILED DESCRIPTION

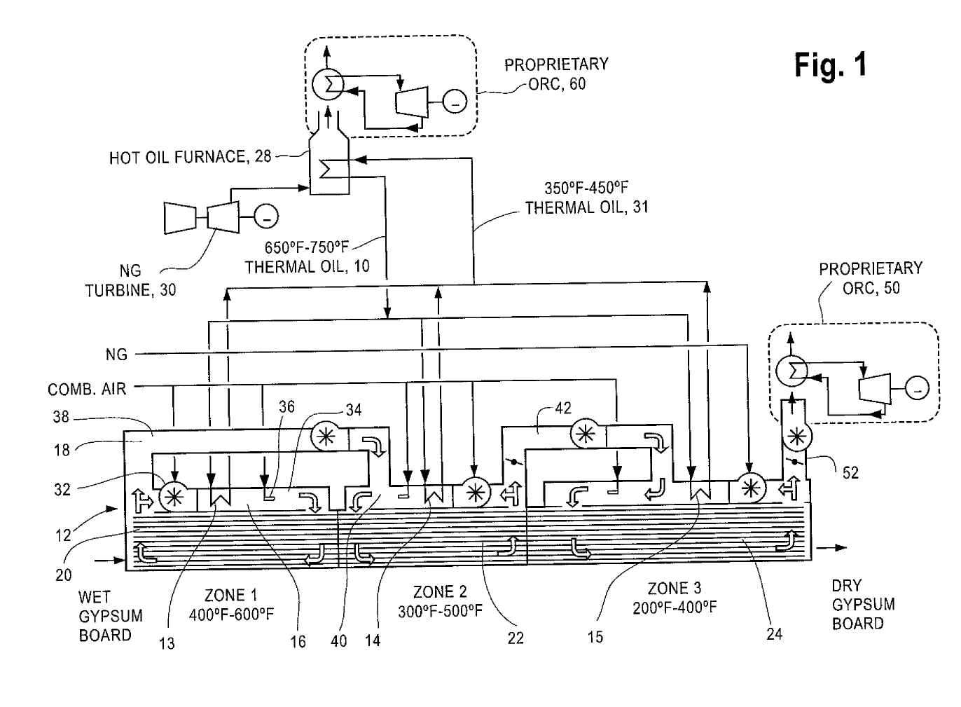

A process and apparatus for drying gypsum wallboard is shown, for example, in FIG. 1. The process uses supplemental radiant heat supplied by circulating heated thermal oil 10. The thermal oil 10 is heated to about 650° F. to about 750° F. using any number of fuels. These include, for example, biomass and other renewable fuels, waste products (including but not limited to paper fiber waste), natural gas and coal, as well as the exhaust from combustion turbines or reciprocating engines 30, as shown in FIG. 1.

The supplemental heat provided by the thermal oil 10 replaces up to 90% of the heat provided by direct-firing. By substituting direct-fired fuel, such as natural gas, with lower cost and/or renewable fuels, or as part of a Combined Heat & Power (CHP) system, the present disclosure allows for significantly lower energy costs and potential reductions in greenhouse gas emissions. Since the exhaust gas from the supplemental heat produced by the thermal oil 10 does not contact the wall board product, contamination of the wallboard is not a concern.

The supplemental heating by use of the thermal oil 10 is achieved by retrofitting existing direct-fired or radiant heat gypsum dryer units 12 with thermal oil-to-air heat exchangers 13, 14, 15 in the combustion air lines 16 and the air recirculation lines 18, as shown in FIG. 1. Thermal oil 10 heated to approximately 700° F. and is circulated through the heat exchangers 13, 14, 15 to provide supplemental heat to both the combustion air and the re-circulated dryer air. The existing natural gas burners are fired to achieve the desired exit temperature in the dryer zones 20, 22, 24. The exit temperature will be varied based on the type of product being produced and the original design of the dryer 12. Typical dryer operations run as high as 600° F. in the first dryer zone 20 of the dryer 12.

Cooled thermal oil 10 is returned to a thermal oil furnace 28 through return lines 31 where the thermal oil 10 is reheated to the required exit temperature. Cooled thermal oil 10 returning to the thermal oil furnace 28 has a temperature from about 350° F. to about 450° F. The thermal oil furnace 28 can be powered by a number of fuels, including but not limited to: biomass and other renewable fuels, waste products (including but not limited to paper fiber waste), natural gas and coal. Another option involves heating the oil using the exhaust of a combustion turbines or reciprocating engines. In this option, the thermal oil furnace 28 is equipped with additional burners to provide supplemental heat in order to ensure the thermal oil 10 can achieve the required exit temperature.

The system is designed in such a way as to not interfere with the normal air flows or temperatures from about 200° F. to about 600° F. in the dryer 12. This allows the process conditions and the final product properties to remain unchanged to produce a consistent gypsum product. The present design also allows the dryer 12 to be operated without the thermal oil loop in service, maintaining the system operating factor.

Dryer 12 is divided into three dryer zones 20, 22, 24 in order to properly dry the gypsum board as shown for example in FIG. 1. The first dryer zone 20 is the hottest, with an operating temperature from about 400° F. to about 600° F. The second dryer zone 22 is adjacent the first dryer zone 20 and has an operating temperature from about 300° F. to about 500° F. The third dryer zone 24 is adjacent the second dryer zone 22 and has an operating temperature from about 200° F. to about 400° F. While three dryer zones are shown the system can be used with various dryer configurations.

Blower 32 in first dryer zone 20 is positioned in plenum 34. Plenum 34 includes first heat exchanger 13. Heat from the direct fired system is added to plenum 34 injection point 36. Heated air enters first dryer zone 20 and enters duct 38. Heated air then enters second dryer zone 22 and circulates through plenum 40, where the air is reheated by second heat exchanger 14 to the desired temperature. Air next passes to duct 42, where the air circulates within the third dryer zone 24 and is reheated by third heat exchanger 15 to the desired temperature.

The present disclosure relates to a device for continuously drying a material such as gypsum board. The apparatus includes a dryer unit having a series of dryer zones. At least one of the dryer zones operates at a temperature that is different from the other dryer zones. A conveyor used to convey the material through the dryer zones. The dryer unit is fitted with thermal oil-to-air heat exchangers to supply heat the dryer zones. The heat exchangers use a thermal oil that is heated by a heat source such as a gas fired furnace. A series of supply lines are used to supply heated thermal oil from the heat source to the heat exchangers and a series of return lines are used to return the thermal oil from the heat exchangers back to the heat source. An organic rankine cycle system is positioned downstream from the dryer zones and is configured to recapture heat generated by the heat exchangers to produce electricity.

The present disclosure also includes the addition a proprietary Organic Rankine Cycle (ORC) system 50 onto the dryer exhaust vent 52. This exhaust stream has a large amount of latent energy due to the high moisture content. The ORC system works by vaporizing a working fluid, such as propane or iso-butane, and passing the vapor through a turbine to produce electricity. The working fluid is then compressed and cooled, before being sent back to the vaporizer. In this case, the working fluid is vaporized by the heat coming from the exhaust of the gypsum board dryer. The system may also include a second ORC system 60 on the thermal oil furnace 28 to recapture heat generated to heat the thermal oil 10. The energy created by the second ORC system 60 can be used to power other operations.

The process for drying a material such as gypsum board requires providing a dryer that is heated by a direct fire method and with supplemental heat from a one or more oil-to-air heat exchangers 13, 14, 15. The dryer includes at least two heat zones where one of the heat zones is at a temperature that is higher than the other heat zone. Heated thermal oil 10 is provided to the heat exchanger to heat the dryer unit 12. The thermal oil 10 is heated using a heat source such as thermal oil furnace 28. A portion of the heat emitted from dryer unit 12 is recovered by the ORC and converted into electricity.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A device for continuously drying a material comprising:
a dryer unit having a series of dryer zones, at least one dryer zone operating at a temperature that is different from the other dryer zones;
a conveyor used to convey the material through the dryer zones;
thermal oil-to-air heat exchangers associated with the dryer and used to supply heat the dryer zones;
a heat source for heating a thermal oil;
a series of supply lines that supply heated thermal oil from the heat source to the heat exchangers;
a series of return lines that return the thermal oil from the heat exchangers back to the heat source;
an organic rankine cycle system positioned downstream from the dryer zones, the organic rankine cycle system configured to recapture heat generated by the heat exchangers to produce electricity.

2. The device of claim 1, wherein the dryer unit includes a first dryer zone operating at a temperature from about 400 degrees Fahrenheit to about 600 degrees Fahrenheit.

3. The device of claim 2, wherein the dryer unit includes a second dryer zone that is positioned downstream from the first dryer zone and operates at a temperature from about 300 degrees Fahrenheit to about 500 degrees Fahrenheit.

4. The device of claim 3, wherein the dryer unit includes a third dryer zone that is positioned downstream from the second dryer zone and operates at a temperature from about 200 degrees Fahrenheit to about 400 degrees Fahrenheit.

5. The device of claim 1, wherein the heat source is a thermal oil furnace.

6. The device of claim 5, wherein the thermal oil furnace is fueled by biomass.

7. The device of claim 5, wherein the thermal oil furnace is fueled by renewable fuels.

8. The device of claim 5, wherein the thermal oil furnace is fueled by waste products.

9. The device of claim 5, wherein the thermal oil furnace is fueled by natural gas.

10. The device of claim 5, wherein the thermal oil furnace is fueled by coal.

11. The device of claim 1, wherein the heat source is exhaust heat from a combustion engine.

12. The device of claim 1, further including a second organic rankine cycle system configured to recapture heat generated by the heat source to produce electricity.

13. A device for heating a material comprising:
a heating unit having configured to operate at a predetermined temperature;
a thermal oil-to-air heat exchanger associated with the heating unit used to supply heat the heating unit;
a heat source for heating the thermal oil;
a supply line configured to supply a heated thermal oil from the heat source to the heat exchanger;
a series of return lines that return thermal oil from the heat exchangers back to the heat source;
an organic rankine cycle system positioned downstream from the dryer zones, the organic rankine cycle system configured to recapture heat generated by the heat exchangers to produce electricity.

14. The device of claim 13, wherein the heat source is a thermal oil furnace.

15. The device of claim 14, wherein the thermal oil furnace is fueled by biomass.

16. The device of claim 14, wherein the thermal oil furnace is fueled by renewable fuels.

17. The device of claim 14, wherein the thermal oil furnace is fueled by waste products.

18. The device of claim 14, wherein the thermal oil furnace is fueled by natural gas.

19. The device of claim 14, wherein the thermal oil furnace is fueled by coal.

20. The device of claim 13, wherein the heat source is exhaust heat from a combustion engine.

21. A process for drying a material comprising the steps of:
providing a dryer having a thermal oil heat exchanger and configured to dry the material, the dryer includes at least two heat zones wherein one of the heat zones is hotter than the other heat zone;
providing a thermal oil to heat the dryer;
heating the thermal oil using a heat source;
conveying the material through the dryer to dry the material; and
recovering a portion of the heat emitted from the dryer and converting the heat into electricity.
